(19) United States
(12) Patent Application Publication
(10) Pub. No.: US 2006/0148375 A1
(43) Pub. Date: Jul. 6, 2006

(54) Puppet book reading system

(76) Inventor: Lisa Leleu, Doylestown, PA (US)

Correspondence Address: Nathaniel Gordon-Clark, 1025 North Calvert Street, Baltimore, MD, 21202, US

(21) Appl. No.: 11/029,255

(22) Filed: Jan. 3, 2005

(51) Int. Cl. A63H 3/14; B42D 3/08

(52) U.S. Cl. 446/327; 281/29

(57) ABSTRACT

This invention is a system that allows a puppet of any size to hold a book of any size. The system requires an attachment method that connects the arms of the puppet to the cover of the book. The preferred embodiment envisions slots near the edge of the book cover that the arms of the puppet fit into. The end of the arms of the puppet has a fastener that folds around the edge of the book, allowing the puppet to grip the book. The only limitation is that the puppet's arms must be able to reach to the edge of the cover of the book.

### CROSS-REFERENCE TO RELATED APPLICATIONS

none

### FEDERALLY SPONSORED RESEARCH

no

### SEQUENCE LISTING OR PROGRAM

none

### FIELD OF INVENTION

This invention relates to toys. More specifically it relates to puppets. Even more specifically it relates to puppets that can hold books.

### BACKGROUND OF THE INVENTION

Puppets have been used in a broad range of contexts and for a large number of purposes. They have been used to both educate and entertain. They have been used in forums as diverse as stages, classrooms and television. Since most puppets are human in body arrangement, with a head and two arms, many puppets use props. The props are usually lightweight and always scaled down versions of real objects. Real objects are two heavy or to large for the puppet to hold or use the object. In turn this meant that the operator of the puppet was limited to using the puppet-sized objects.

### SUMMARY OF INVENTION

This invention is a system by which a puppet of any size can use its arms to hold a regular book of any size. This allows a puppet operator to create the illusion that a puppet is reading a book. The operator attaches any regular book to the hands of the puppet, then uses the puppet in the normal manner. The puppet attaches to the book by a fastener that is attached to the puppets hands or arms. The corresponding fastener is attached to the cover of the book. The puppet then grasps the book by attaching the corresponding fastener on the book to the fastener on the puppets hands or arms.

The purpose of this invention is to allow any puppet to read any book. Thus the fastener that attaches the puppet's hands or arms to the book can be permanent or reversible. Examples of possible reversible fasteners are snaps, magnets, adhesive pads, hook and loop fasteners, statistical fasteners, such a VELCRO, or buttons. The only requirement is that one half of the fastener combination is attached to the puppet's arms or hands and the other to the book cover. These fastener components can in turn be permanently or reversibly attached to the puppet or book cover. Thus a single puppet can use many books by having the operator move the corresponding fastener from one book to another book. Examples of methods by which the fastener can be attached to the book covers are suction cups or adhesive pads.

### BRIEF DESCRIPTION OF THE DRAWINGS

The accompanying drawings, which are incorporated in and form part of the specification, illustrate the embodiments of the present invention and, together with the description, serve to explain the principles of the invention.

FIG. 1 is a picture of a puppet 1 holding a book cover 2 with it arms 3.

FIG. 2 is a picture of a book cover 2 showing the slot 4 through which a puppet's 1 arm 3 could be placed.

FIG. 3 is a picture of a book cover 2 with the arm 3 of a puppet 1 inserted through slot 4. The fastener 5 is not fastened in this picture.

FIG. 4 is a picture of a puppet 1 from behind holding a book cover 2 with its arms 3. The arms 3 are inserted in the slots 4 and the fastener 5 is fastened, folding over the arm 3.

FIG. 5 is a picture of a person 6 operating puppet 1 so that it is holding book cover 2 by its arms 3, creating the illusion that the puppet is reading the book within book cover 2.

### DETAILED DESCRIPTION OF THE DRAWINGS

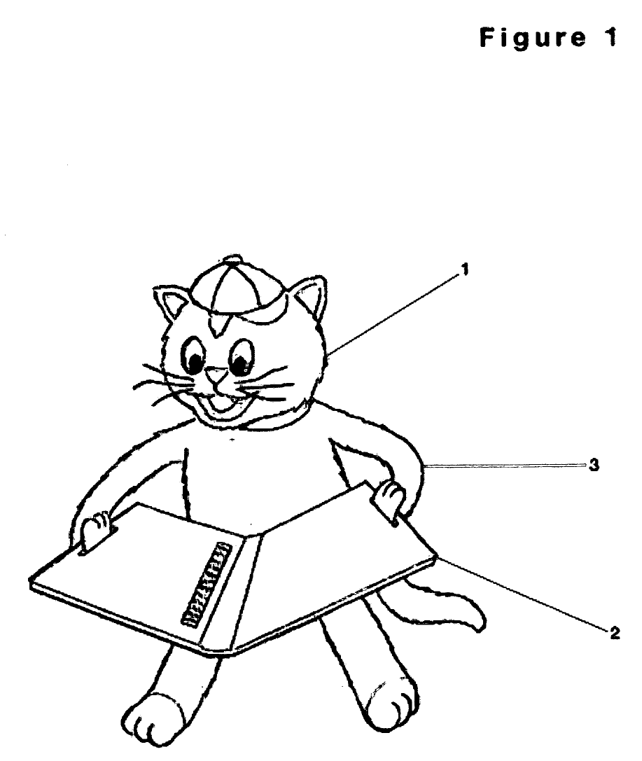

FIG. 1 illustrates a puppet 1 holding a book cover 2 with its arms 3. The puppet 1 can be any size. The size of the puppet does not affect the function of the invention, but it will affect the size of the book cover 2 that the puppet 1 can hold. The size of the book cover 2 that the puppet 1 can hold is determined by the length of the arms 3 of the puppet 1. The arms 3 must be able to reach out far enough to support the book. This relationship can be determined by any person skilled in the art. The book cover 2 can also be of any size and any weight. The only limit on the size of the book cover 2 is that the arms 3 of the puppet 1 must be able to support the book cover 2. The only limit on the weight of the book cover 2 is that the fasteners 5 must be able to support the weight of the book cover 2 and its contents and still remain fastened.

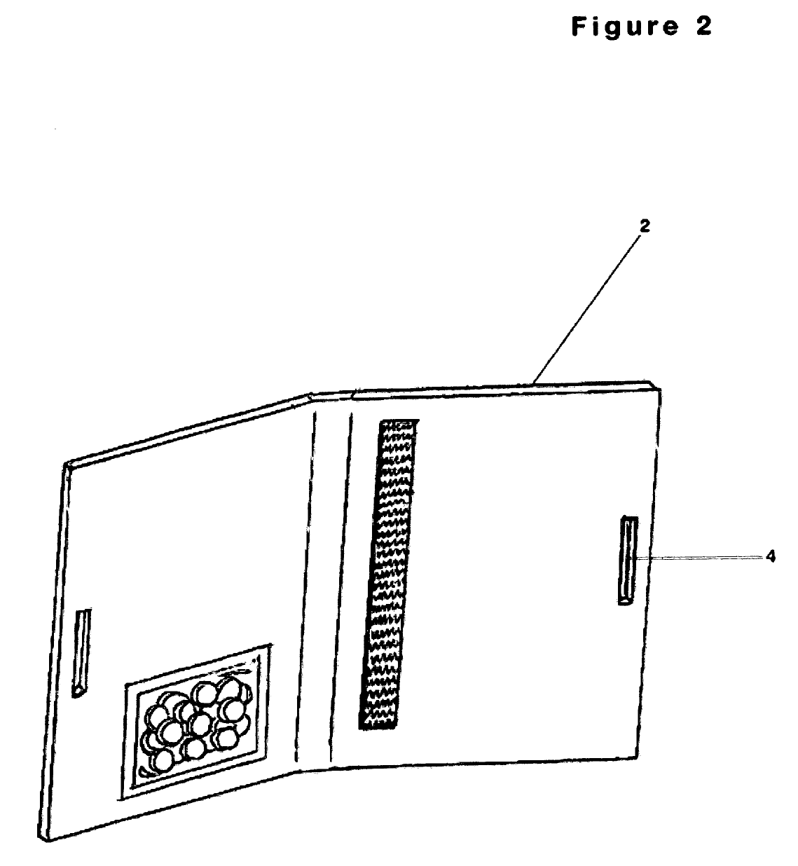

FIG. 2 is a view of just a book cover 2. It shows slot 4 through which the puppet 1 can slide its arm 3. The book cover 2 can be attached to a book or booklet. Alternatively, the book cover 2 can be just a book cover without containing any pages. The book cover 2 can be made of any material. In the preferred embodiment, the book cover 2 is a stiff cardboard, but any material will do. The book cover 2 can be made of any stiff or flexible material.

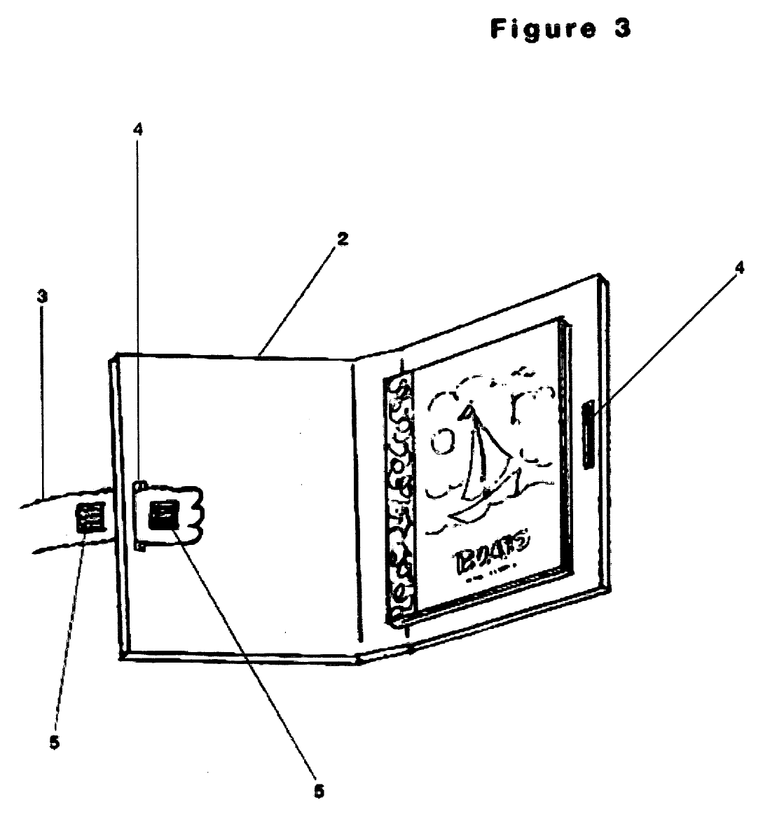

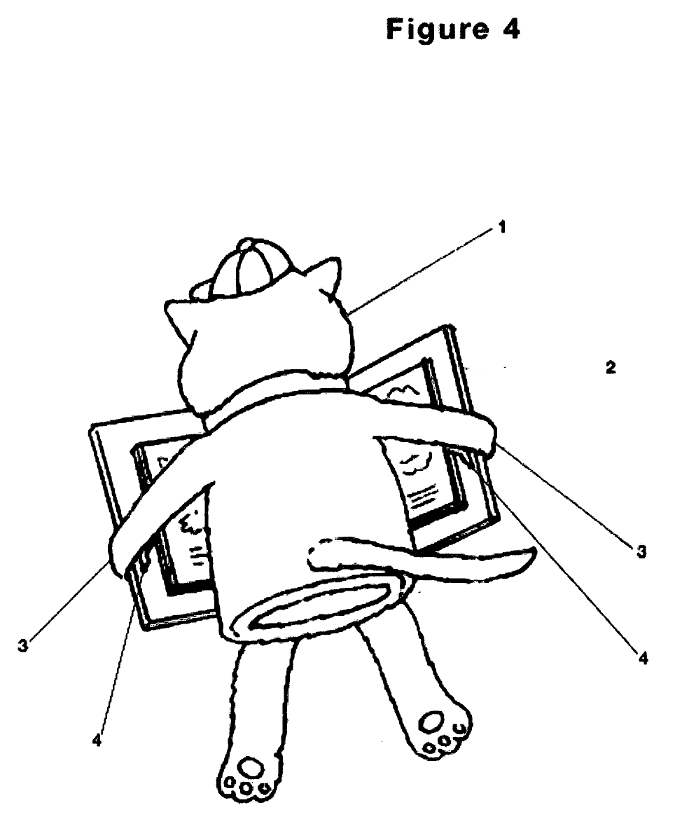

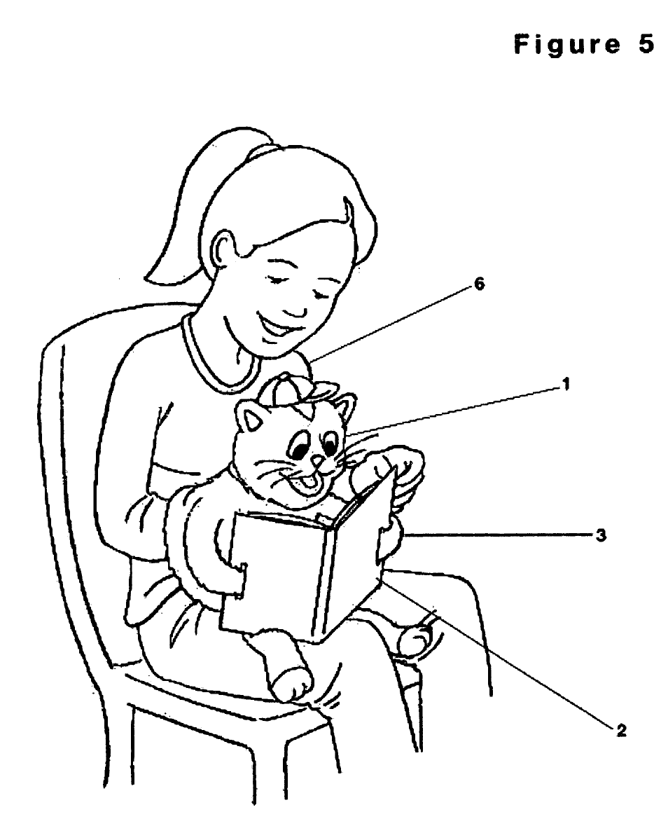

FIG. 3, FIG. 4 and FIG. 5 all show the invention in operation. FIG. 3 shows the book cover 2 with the puppets 1 arm 3 through slot 4 and the fastener 5 not attached. FIG. 4 shows the puppet 1 with its arm 3 through slot 4 and fastener 5 attached. FIG. 5 shows puppet 1 holding a book cover 2 while being operated by a person 6. In all these drawings, the book cover 2 is held by the puppet 1 using fasteners 5. These fasteners maybe of any type. As an example, and not meant to be limiting in any way, the fasteners 5 may be snaps, buttons, magnets, suction cups, statistical fasteners such as VELCRO, insert and slot combinations and any combination of these fasteners. The fasteners 5 can be permanently attached or can be reversibly attached. In the case of reversibly attached fasteners, a single puppet 1 could be used to hold many different book covers 2 by releasing the book cover 2 by unfastening the fastener 5 and using a new book cover 2. This is the system envisioned in the preferred embodiment.

In the preferred embodiment, the arms 3 are inserted into slots 4 on the book cover 2. The arms 3 have fasteners 5 attached that are made of a statistical fastener such as VELCRO. The arm 3 is then folded over so that it touches itself and the two parts of the Statistical fastener meet, thus fastening the arm 3 around the edge of the book cover

In the preferred embodiment, the limit on the size of the book cover 2 is that the arms 3 of the puppet 1 must be able to reach the edge of the book cover 2 where the slots 4 are located. Other embodiments could have slots 4 placed in a different location on book cover 2 that would allow a smaller puppet 1 or arms 3 that are shorter.

In the preferred embodiment, the fastener 5 is attached only to the arms 3. In the preferred embodiment, the fastener 5 causes the arm 3 to form a loop that holds the book cover 2 by the slot 4. In other embodiments, the fastener 5 can have half the fastener on the arm 3 and the corresponding fastener 5 on the book cover 2. For instance, and not meant as a limitation in any way, the grab fabric half of a statistically fastener like VELCRO could be attached to the arm 3 of a puppet 1. The hook fabric half of the statistical fastener could be on the book cover 2. By matching the two halves of the fastener together, the puppet 1 can be made to hold the book cover 2. Such a system could use book covers 2 that do not have slot 4. Possible fasteners could be snaps, buttons, magnets, suction cups, statistical fasteners such as VELCRO, insert and slot combinations and any combination of these fasteners.

The fastener 5 could itself be reversibly attached to the arm 3 of the puppet 1 or to the book cover 2. In the case were fastener 5 is reversibly attached to the arm 3 of the puppet 1, a single attachment system could be used on many puppets 1. The fastener 5 could also be reversibly attached to the book cover 2. This would allow any book cover 2, and thus any book, to be used with a given puppet. The possible methods of attaching the fastener reversibly to the puppet 1 or the book cover 2 should be clear to any person skilled in the art. Possible attachment methods are snaps, buttons, magnets, suction cups, statistical fasteners such as VELCRO, insert and slot combinations and any combination of these fasteners. In the preferred embodiment, a piece of material with slot 4 in it could be reversibly attached to the book cover 2. This would allow the preferred embodiment to use any book as the book cover 2.

In the preferred embodiment, the book cover 2 contains a book, pamphlet of collection of pages. The pages attached to book cover 2 may be permanently or reversibly attached to book cover 2. Book cover 2 may be an integral part of the book or pamphlet that book cover 2 is attached to. If the book or pamphlet is reversibly attached to the book cover 2, the reverable attachment method can be any that allows the book or pamphlet to be attached and detached from the book cover 2. Persons skilled in the art will be aware of various possible attachment methods.

Although this invention has been illustrated by reference to specific embodiments, it will be apparent to those skilled in the art that various changes and modification may be made which clearly fall within the scope of the invention. The invention is intended to be protected broadly within the spirit and scope of the appended claims.

What is claimed is:

1. A Puppet Book Reading System comprising a puppet with a fastener attached to the puppet, a corresponding fastener attached to a book cover such that the puppet appears to be holding the book.

2. The puppet from claim 1 further comprising a fastener that reversibly attaches to it's corresponding fastener.

3. The puppet from claim 2 further comprising a corresponding fastener that is reversibly attached to the book cover.

4. The book cover from claim 1 further comprising a book.

5. The book cover from claim 1 further comprising a booklet.

6. The book cover from claim 1 further comprising a plurality of pages attached to the book cover.

7. The book cover from claim 2 further comprising a book.

8. The book cover from claim 2 further comprising a booklet.

9. The book cover from claim 2 further comprising a plurality of pages attached to the book cover.

10. The book cover from claim 3 further comprising a book.

11. The book cover from claim 3 further comprising a booklet.

12. The book cover from claim 3 further comprising a plurality of pages attached to the book cover.

13. The puppet from claim 3 further comprising a corresponding fastener that is reversibly attached to the book cover.

14. A Puppet Book Reading System comprising a book with a plurality of fasteners reversibly attached to a book,
the plurality of fasteners can be reversibly attached to a plurality of corresponding fasteners,
the plurality of corresponding fasteners are permanently attached to a plurality of hands of a puppet so that the puppet appears to be holding the books as if to read it.

15. A Puppet Book Reading System comprising a puppet with arms and a body,
a fastener is attached to the arms of the puppet at the most extreme end of the arm from the body of the puppet,
a corresponding fastener to the faster is attached to the arm at a point near the fastener,
a book cover with a slot near the edge of the book cover, so that the arms of the puppet can be inserted in to the slots on the book cover and then folded over the edge of the book cover so that the fastener reversibly fastens to the corresponding fastener creating a loop with the end of the arm so that it appears that the puppet is holding the book cover as if to read the book covers contents.

16. A Puppet Book Reading System from claim 15 further comprising a square of material that contains a slot and a fastener that can be reversibly attached to the book cover to that the arms of the puppet can be inserted in the slots on the square of material and then be folded over to fasten the fastener and corresponding fastener on the arms of the puppet so that the puppet is holding the book cover as if it is reading the contents of the book cover.
